(19) United States
(12) Patent Application Publication
(10) Pub. No.: US 2020/0308852 A1
(43) Pub. Date: Oct. 1, 2020

(54) STRUCTURE EDGE PROTECTION DEVICE HAVING DAMPING ROLLERS

(71) Applicant: Jin Ok KIM, Seoul (KR)

(72) Inventor: Jin Ok KIM, Seoul (KR)

(21) Appl. No.: 16/089,705

(22) PCT Filed: Jun. 27, 2017
(86) PCT No.: PCT/KR2017/006743

§ 371 Date: Sep. 28, 2018

(30) Foreign Application Priority Data
Jul. 11, 2016 (KR) 10-2016-0087734

(51) Int. Cl. E04F 19/02; G08B 21/18

(52) U.S. Cl. CPC E04F 19/028; G08B 21/18

(57) ABSTRACT

A structure edge protection device having damping rollers of the present invention includes: a frame that can be fastened to an edge of a structure such as a wall or a column; a plurality of rotary rollers that is made of synthetic resin and can rotate on the structure in a movement direction of a impacting object such as a vehicle or freight that is being carried; rotary shafts that support the rotary rollers and are inserted in the rotary rollers for smooth rotation of the rotary rollers; elastic members that can absorb shock that is applied to the structure and the impacting object by contracting and stretching when the impacting object collides with the structure; a sensor unit that can sound an alarm by sensing approach of an object; and connection straps that can strongly fasten a plurality of frame units by being fastened through the frame units.

### TECHNICAL FIELD

The present invention relates to a structure edge protection device having damping rollers and, more particularly, to a edge protection device having damping rollers, the device can reduce damage to an impacting object and a structure by preventing a collision of the impacting object such as a vehicle or freight that is being carried with a structure such as a wall or a column and by absorbing shock that is applied to the impacting object and the structure when a collision occurs.

### BACKGROUND ART

In general, a wall or a column, which is an upright structure constituting a building, forms a residence space by supporting the loads of a roof, a floor, and an upper part such as a beam. Further, several walls or columns are constructed in large building or warehouses so that vehicles can be parked or freight can be loaded in the spaces among them. Vehicles or freight that is carried frequently collide with the walls or columns that are constructed in a parking lot of medium and large buildings or warehouses due to poor driving of drivers or workers. The impacting objects, i.e. the vehicles or freight that is being carried are damaged due to a collision and the structures such as the walls and columns are also damaged, so the safety of the building may be deteriorated.

For this problem, a method of constructing an edge protector for columns in a parking lot has been disclosed in Korean Patent Application No. 10-2005-0031696, titled “Construction method for corner protection unit of parking lot pillar”. The method can attenuate shock that is applied to the columns of a building and a vehicle when the vehicle collides with the columns, using a shock-absorbing pad, and can improve installation because the shock-absorbing pad is fastened to a column of a building only by fixing bolts without a support bracket.

However, the method absorbs shock that is applied to a vehicle and a column of a building, using the elasticity of the shock-absorbing pad, so the degree of absorbing shock by the shock-absorbing pad is reduced when a heavy vehicle or a high-speed vehicle hits against a column, and accordingly, damage to vehicles and columns cannot be prevented. Further, the shock-absorbing pad contracts or expands due to a temperature change at the installation place, so it deforms or detaches, and accordingly, it may be separated from the column to which it has been fastened in a building.

In order to solve this problem, the present invention provides a structure edge protection device having damping rollers, the device being able to reduce damage to an impacting object and a structure by absorbing shock that is applied to the impacting object or the structure when an impacting object such as a vehicle or freight that is being carried collides with a structure such as a wall or a column, using rotary rollers being able to rotate in the movement direction of a vehicle or freight that is being carried and elastic members being able to control the horizontal positions of the rotary rollers by contracting or stretching, and that can let a driver or a worker know that a vehicle or freight that is being carried approaches a structure, using a sensor unit that can sense whether an object approaches or not.

### DISCLOSURE

### Technical Problem

The present invention has been made in an effort to solve the problems and relates to a structure edge protection device having damping rollers. An object of the present invention is to provide a structure edge protection device having damping rollers, the device including: rotary rollers being able to rotate in the movement direction of a vehicle or freight that is being carried; elastic members being able to control the horizontal positions of the rotary rollers by contracting or stretching; and a sensor unit being able to sense whether an object approaches or not to prevent a collision of a vehicle or freight that is being carried in order to reduce damage to an impacting object and a structure by absorbing shock that is applied to the impacting object or the structure when an impacting object such as a vehicle or freight that is being carried collides with a structure such as a wall or a column.

### Technical Solution

In order to solve the problems,

the present invention provides a structure edge protection device having damping rollers, the device including: a frame that can be fastened to an edge of a structure such as a wall or a column; a plurality of rotary rollers that is made of synthetic resin and can rotate on the structure in a movement direction of an impacting object such as a vehicle or freight that is being carried; rotary shafts that support the rotary rollers and are inserted in the rotary rollers for smooth rotation of the rotary rollers; elastic members that can absorb shock that is applied to the structure and the impacting object by contracting and stretching when the impacting object collides with the structure; a sensor unit that can sound an alarm by sensing approach of an object; and connection straps that can strongly fasten a plurality of frame units by being fastened through the frame units.

### Advantageous Effects

The present invention provides a structure edge protection device having damping rollers. According to the present invention, the contact area between a impacting object and a structure such as a wall or a column is minimized by the rotary rollers that can rotate in the movement direction of an impacting object such as a vehicle or freight that is being carried collides with the structure due to poor driving of a driver or a worker, so shock that is applied to the impacting object and the structure can be reduced. Further, the horizontal positions of the rotary rollers are controlled by the elastic members that can contract and stretch, depending on the pressure applied to the rotary roller in a collision, so the shock that is applied to the impacting object and the structure is absorbed, whereby it is possible to reduce damage to the impacting object and the structure.

Further, according to the present invention, a driver or a worker can recognize that an object approaches a structure by the sensor unit that can sense an approaching object and sound an alarm, so it is possible to prevent a collision of a vehicle or freight that is being carried with a structure.

### DESCRIPTION OF DRAWINGS

FIG. 1 is an exemplary view of a structure edge protection device having damping rollers;

FIGS. 2 and 3 are exploded and assembled views of the structure edge protection device having damping rollers;

FIG. 4 is a cross-sectional view illustrating assembly and disassembly of structure edge protection device having damping rollers;

FIG. 5 provides an embodied view and a detailed view showing rotation of rotary rollers and contraction of elastic members of the structure edge protection device having damping rollers;

FIG. 6 provides a cross-sectional view and a detailed view showing rotation of rotary rollers and a sensor unit and contraction of elastic members of the structure edge protection device having damping rollers;

FIG. 7 is an exemplary view of fastening the structure edge protection devices having damping rollers to the edges of a column;

FIG. 8 is an exemplary view of fastening the structure edge protection device having damping rollers to an edge of a wall;

FIG. 9 provides an embodied view and a detailed cross-sectional view of the structure edge protection device having damping rollers; and

FIG. 10 is a reference view of the structure edge protection device having damping rollers.

### BEST MODE

Hereafter, the present invention is described in detail with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

[symbol]

Accordingly, it should be appreciated that there may be various equivalents and modifications that can replace the embodiments and the configurations at the time at which the present application is filed.

[symbol]

The present invention relates to a structure edge protection device having damping rollers, which includes: a frame 100 that can be fastened to an edge of a structure 700 such as a wall or a column; a plurality of rotary rollers 200 that is made of synthetic resin and can rotate on the structure 700 in a movement direction of a impacting object 800 such as a vehicle or freight that is being carried; rotary shafts 300 that are coupled over the front side of the frame 100 and are longitudinally inserted in the centers of the rotary rollers 200, respectively, for smooth rotation of the rotary rollers 200; elastic members 400 that can be inserted in upper and lower portions of the frame 100 and can absorb shock that is applied to the structure 700 and the impacting object 800 by controlling horizontal positions of the rotary rollers by contracting or stretching, depending on pressure applied to the rotary roller 200, in a collision by the impacting object 800; a sensor unit 500 that may be fastened to a side of the top of the frame 100 and can sound an alarm by sensing an approach of an object; and connection straps 600 that can strongly couple a plurality of frames 100 fastened to edges of the structure 700 by being fastened through the frames 100.

[symbol]

In more detail,

the frame 100 includes: a mounting plate 110 being formed at right angle and having an L-shaped cross-section to correspond to the shape of an edge of the structure 700 such as a wall or a column so that the frame 100 can be stably fastened; a top protrusive holder 120 and a bottom protrusive holder 130 protruding outward in “ [symbol] ” shape from the upper and lower ends of the front of the mounting plate 110 to hold the rotary shafts 300 inserted in the rotary rollers 200 over the front side of the mounting plate 110 and to form a shock-absorbing space that can attenuate shock applied to the structure 700 and the impacting object 800 in a collision of the impacting body 800 with the structure 700; strap holes 140 formed through upper and lower portions of the mounting plate 110 to pass the connection straps 600 that can strongly couple the frames 100 when the frames 100 are fastened to the structure 700; bolt holes 150 formed between the strap holes 140 of the mounting plate 110 so that the frame 100 can be fastened to an edge of the structure 700 by bolts 620; and a sensor seat 160 protruding upward from a side on the top of the top protrusive holder 120 and having a T-shaped recession 161 so that the sensor unit 500 that can sound an alarm by sensing approach of an object can be fastened to the top of the frame 100, in which top rotary shaft grooves 121 and bottom rotary shaft grooves 131 are formed in oblong shapes respectively on the bottom of the top protrusive holder 120 and the top of the bottom protrusive holder 130 so that the upper and lower ends of the rotary shafts 300 are inserted therein and the rotary shafts 300 can smoothly horizontally rotate. Further, elastic members holes 170 are formed at first sides from the top rotary shaft grooves 121 and the bottom rotary shaft grooves 131 so that the elastic members 400 that can contract or stretch when the impacting object 800 collides with the structure 700 can be inserted in the frame 100. Second sides of the top rotary shaft grooves 121 with the elastic body holes 170 at the first sides, unlike the bottom rotary shaft grooves 131, are open so that the rotary shafts 300 can be inserted from the front of the top protrusive holder 120, and protrusive retainers 122 protruding inward are formed inside the open sides to prevent separation of the upper ends of the rotary shafts 300 inserted in the top rotary shaft grooves 121.

[symbol]

The rotary rollers 200 are formed in a cylindrical shape to be able to attenuate shock that is applied to the structure 700 and the impacting object 800 by minimizing a contact surface with the impacting object 800 by rotating in the movement direction of the impacting body 800 when the impacting body 800 hits against the structure 800, and each have a central hole 210 longitudinally formed through the center thereof to receive the rotary shafts 300.

The sensor unit 500 includes: a sensor 510 that can sense an approach of an object; an alarm 520 that is disposed on the top of the sensor 510 and can sound an alarm when an object approaches; a switch 530 that is disposed on a side of the sensor 510 to control whether to operate the sensor 510; a coupler 540 that protrudes downward from the bottom of the sensor 510 and has a locking ball hole 541 at the center; a locking ball 541 that is formed in a spherical shape corresponding to the diameter of the locking ball hole 541 to be inserted in the locking ball hole 541 of the coupler 540 so that the sensor 510 can rotate left and right to correspond to an object that approaches at various angles; an height adjuster 560 that protrudes downward from the bottom of the locking ball 550 and can determine the vertical position of the sensor 510 coupled to the locking ball 550; and an insert 570 that has a T-shaped cross-section corresponding to the recession 161 to be inserted into the recession 161 of the sensor seat 160 of the frame unit 100 so that the sensor unit 500 is integrally coupled to the frame unit 100.

[symbol]

The connection straps 600 can fasten a plurality of frame units 100 by being inserted in the strap holes 140 formed through the mounting plates 110 of the frame units 100 and each have a Velcro tape 610 on the front and rear sides of both ends so that the frames 100 integrally connected by the connection straps 600 can be stably fixed on the outer side of the structure 700.

[symbol]

As an embodiment,

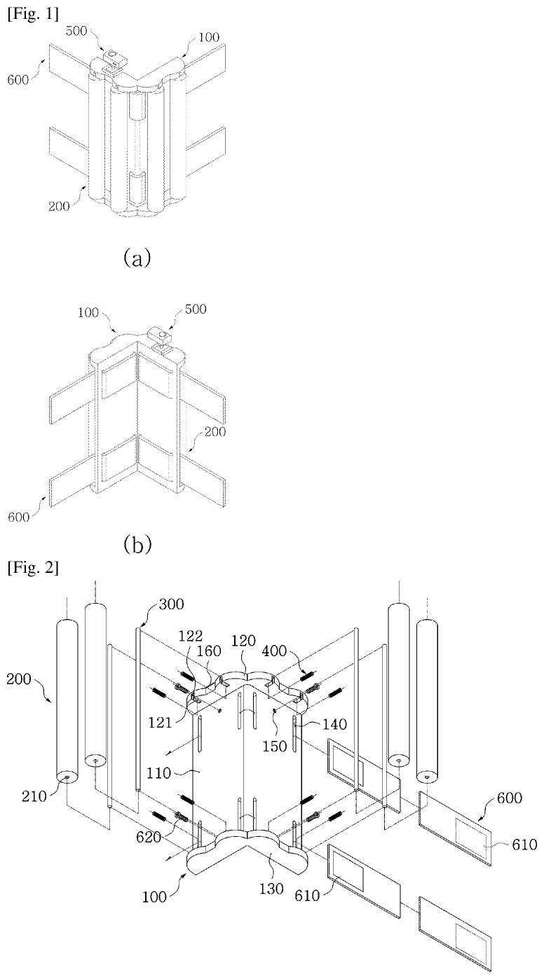

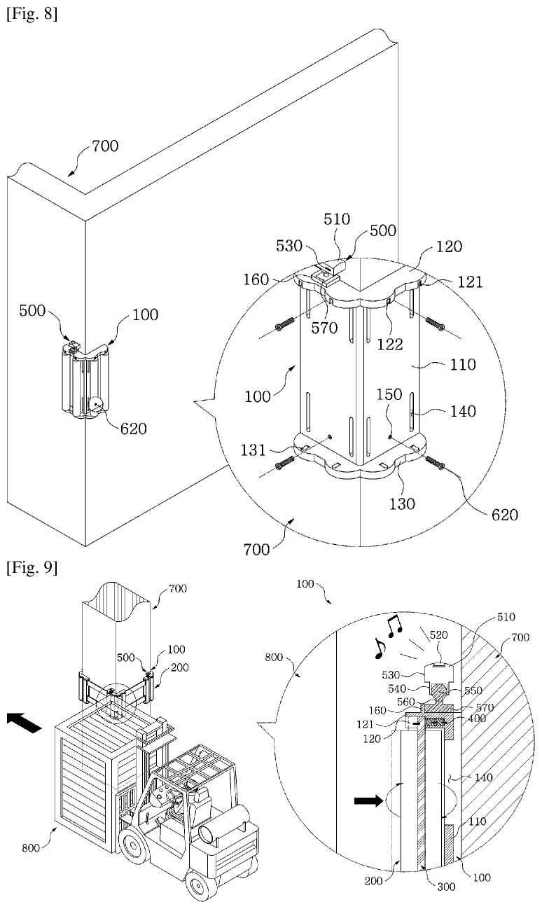

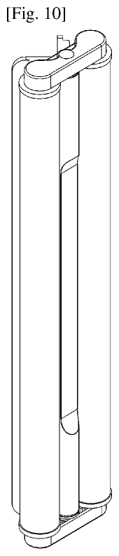

when a plurality of frame units 100 is fastened on the edges of the structure 700 that is a rectangular wall or column, as shown in FIG. 2, the connection straps 600 are inserted through the oblong strap holes 140 formed at the upper and lower portions of the mounting plates 110 of the frame units 100, thereby integrally connecting the frames 100. Further, as shown in the detailed view of FIG. 7, the Velcro tapes 610 on the front and rear sides of both sides of the connection straps 600 are attached to each other, whereby the frames units 100 integrally connected by the connection straps 600 can be fastened on the edges of the structure 700. When a single frame unit 100 is fastened on an edge of the structure, as shown in the detailed views of FIGS. 2 and 8, bolts 620 are inserted in the structure 700 through the bolt holes 150 formed through the mounting plate 110, whereby the frame unit 100 can be stably fastened.

[symbol]

The rotary rollers 200 can be fitted on the rotary shafts 300 by the central holes 210 longitudinally formed through the centers of the rotary rollers 200. The upper ends and lower ends of the rotary shafts 300 are inserted between the top protrusive holder 120 and the bottom protrusive holder 130 of the frame unit 100 fastened on the structure, so the rotary shafts 300 can be coupled over the front of the frame unit 110 with the rotary rollers 200 fitted thereon. That is, the lower ends of the rotary shafts 300 are inserted first into the bottom rotary shaft grooves 131 formed on the top of the bottom protrusive holder 130 and then the upper ends of the rotary shafts 300 are inserted into the top rotary shaft grooves 121 formed on the bottom of the top protrusive holder 120 from the open sides, whereby the rotary shafts 300 can be coupled over the front of the frame unit 100. In this state, the upper ends of the rotary shafts 300 are fixed by the protrusive retainers 122 protruding inward inside the open sides of the top rotary shaft grooves 121, so the rotary shafts 300 cannot be separated forward from the frame unit 100.

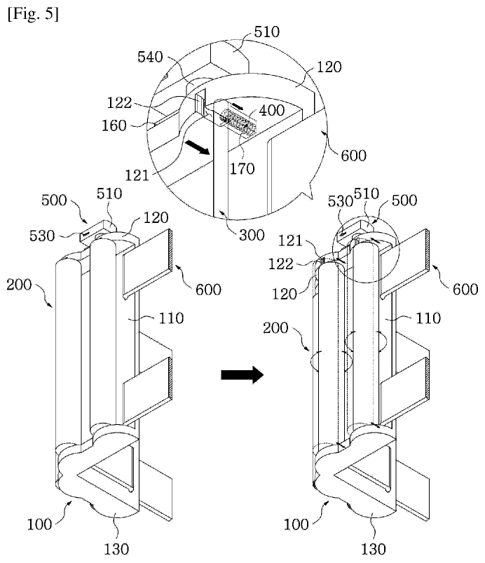

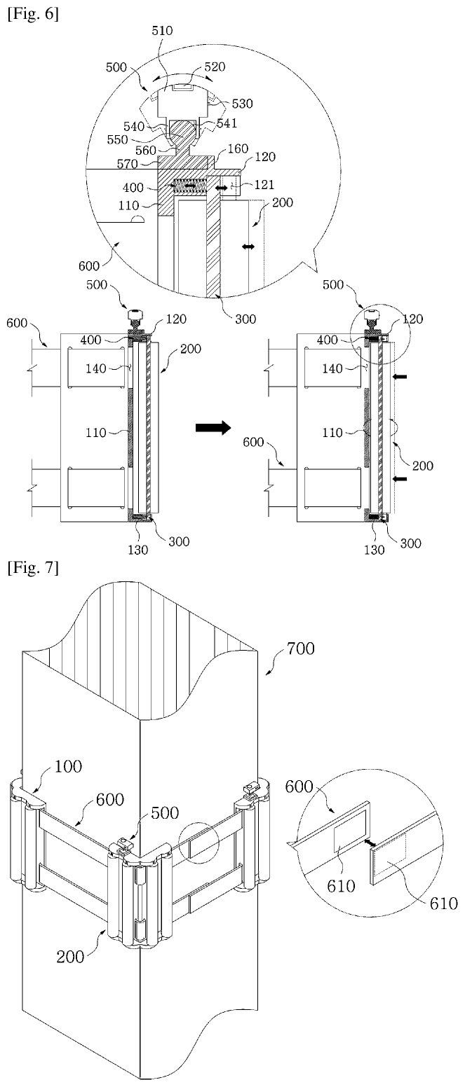

When the impacting object 800 such as a vehicle or freight that is being carried hits against the rotary rollers 200 coupled with the rotary shafts 300 inserted therein over the front side of the frame unit 100, as shown in FIG. 9, the rotary rollers 200 with the rotary shafts 300 inserted therein are rotated about the rotary shafts 300 in the movement direction of the impacting object 800, as shown in FIGS. 5 and 6, so the contact area with the impacting object 800 can be minimized. Further, the rotary shafts 300 inserted in the rotary rollers 200 are horizontally moved between the top protrusive holder 120 and the bottom protrusive holder 130 by the pressure applied to the outer sides of the rotary rollers 200, so the shock that is applied to the structure 700 and the impacting object 800 can be attenuated. That is, as shown in the detailed views of FIGS. 5 and 6, by the pressure applied to the outer sides of the rotary rollers 200, the upper and lower ends of the rotary shafts 300 press first sides of the elastic members 400 inserted in the elastic member holes 170 of the frame unit 100, so the elastic members 400 can contract. Accordingly, the rotary shafts 300 are horizontally moved in the top rotary shaft grooves 121 and the bottom rotary shaft grooves 131 in which the upper and lower ends of the rotary shafts 300 are inserted, so the shock that is applied to the structure 700 and the impacting object 800 can be absorbed.

[symbol]

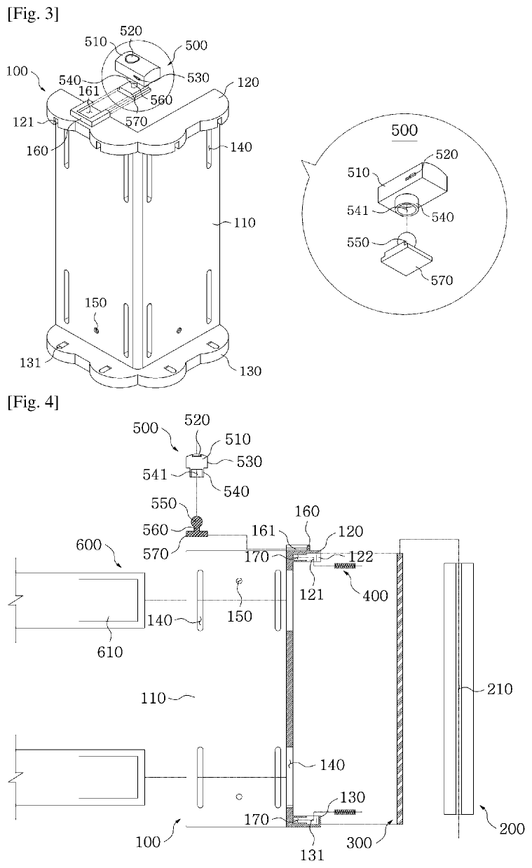

Since the insert 570 is inserted in the recession 161 of the sensor seat 160 of the frame unit 100, as shown in FIG. 3, the sensor unit 500 can be fastened to a side on the top of the top protrusive holder 120 of the frame unit 100. Further, as shown in the detailed view of FIG. 9, the sensor 510 senses that a vehicle or freight that is being carried approaches the structure 700 and the alarm 520 sounds an alarm, so a driver or a worker can recognize approach of the vehicle or the freight, whereby it is possible to prevent a collision of the vehicle or the freight that is being carried with the structure 700. Further, as shown in the detailed view of FIG. 3, since the spherical locking ball 550 is inserted in the locking ball hole 541 formed at the center of the connector 540 and the locking ball hole 541 rotates forward/backward and left/right on the locking ball 550, as shown in the detailed view of FIG. 6, the sensor 510 of the sensor unit 500 can effectively deal with an object approaching at various angles.

The configurations and operation principles of the sensor 510 and the alarm 520 can be inferred from the related art, so they are not described herein.

Hereinabove, although the present invention is described by specific matters such as concrete components, and the like, embodiments, and drawings, they are provided only for assisting in the entire understanding of the present invention. Therefore, the present invention is not limited to the embodiments. Various modifications and changes may be made by those skilled in the art to which the present invention pertains from this description.

Therefore, the sprit of the present invention should not be limited to the above-described embodiments, and the following claims as well as all modified equally or equivalently to the claims are intended to fall within the scope and spirit of the invention.

### DESCRIPTION OF THE REFERENCE NUMERALS IN THE DRAWINGS

100: Frame unit
110: Mounting plate
120: Top protrusive holder
121: Top rotary shaft groove
122: Protrusive retainer
130: Bottom protrusive holder
131: Bottom rotary shaft groove
140: Strap hole
150: Bolt hole
160: Sensor seat
161: Recession
170: Elastic member hole
200: Rotary roller
210: Central hole
300: Rotary shaft
400: Elastic member
500: Sensor unit
510: Sensor
520: Alarm
530: Switch
540: Connector
541: Locking ball hole
550: Locking ball
560: Height adjuster
570: Insert
600: Connection strap
610: Velcro tape
620: Bolt
700: Structure
800: Impacting object

1. A structure edge protection device having damping rollers, the device comprising:
a frame including mounting plate bending with an L-shaped cross-section to be fastened to an edge of a structure such as a wall or a column, a top protrusive holder protruding outward in a “ [symbol] ” shape from an upper end of a front side of the mounting plate, having top rotary shaft grooves formed in an oblong shape with an open side on a bottom thereof, and having protrusive retainers protruding inside the open sides of the top rotary shaft grooves and bottom rotary shaft grooves protruding in a “ [symbol] ” shape from a lower end of the front side of the mounting plate and having rotary shaft grooves formed in an oblong shape on a top thereof;
cylindrical rotary rollers capable of rotating in a movement direction of an impacting object such as a vehicle or freight that is being carried, when the impacting object hits against the structure, and each having central holes longitudinally formed through a center;
rotary shafts inserted in the central holes of the rotary rollers to support the rotary rollers and allow for rotation of the rotary rollers and having upper end lower ends inserted in the top rotary shaft grooves and the bottom rotary shaft groves of the frame unit;
strap holes formed through upper and lower portions of the mounting plate of the frame unit; and
connection straps each having a Velcro tape on front and rear sides of both ends and being fastened through the strap holes,
wherein a plurality of frame units can be integrally coupled by fastening the connection straps through the strap holes of the frame units, the integrally coupled frames can be fastened on edges of a structure by the Velcro tape, and when an impacting object collides with the structure, shock that is applied to the impacting object and the structure can be attenuated by rotation of the rotary rollers with the rotary shafts inserted therein.

2. The device of claim 1, wherein the frame unit further includes:
elastic member holes formed at first sides from the top rotary shaft grooves and the bottom rotary shaft grooves; and
elastic members capable of contracting and stretching, depending on whether an external force is applied, and inserted in the elastic member holes,
wherein when an impacting object collides with the rotary rollers, the elastic members control horizontal positions of the rotary rollers by contracting due to pressure applied to the rotary rollers, so shock that is applied to the impacting object and the structure can be absorbed.

3. The device of claim 1, wherein the frame unit further includes:
a sensor seat protruding upward from a side on a top of the top protrusive holder and having a T-shaped recession at a side; and
a sensor unit including a sensor capable of sensing an approaching object, an alarm capable of sounding an alarm when the object approaches, a switch capable of controlling whether to operate the sensor, a height adjuster capable of determining a vertical position of the sensor, and an insert having a T-shaped cross-section to be inserted in the recession of the sensor seat,
wherein when a vehicle or freight that is being carried approaches a structure, an alarm is sounded so that a driver or a worker can recognize approach to the structure, thereby being able to prevent a collision of the vehicle or freight that is being carried with the structure.

4. The device of claim 3, wherein the sensor unit further includes:
a connector protruding downward from a bottom of the sensor and having a locking bole hole at a center; and
a locking ball formed in a spherical shape corresponding to a diameter of the locking ball hole to be inserted in the locking ball hole,
wherein the locking ball hole fitted on the locking ball rotates forward/backward and left/right on the locking ball, whereby the sensor can deal with an object approaching at various angles.
